(19) United States
(12) Patent Application Publication
(10) Pub. No.: US 2024/0154491 A1
(43) Pub. Date: May 9, 2024

(54) MOTOR

(71) Applicant: LG INNOTEK CO., LTD., Seoul (KR)

(72) Inventor: Tae Ho KIM, Seoul (KR)

(21) Appl. No.: 18/548,626

(22) PCT Filed: Mar. 16, 2022
(86) PCT No.: PCT/KR2022/003654

§ 371 Date: Sep. 1, 2023

(30) Foreign Application Priority Data
Apr. 8, 2021 (KR) 10-2021-0045873

(51) Int. Cl. H02K 5/22; H02K 5/02; H02K 7/00

(52) U.S. Cl. CPC H02K 5/225; H02K 5/02; H02K 7/003; H02K 2203/09

(57) ABSTRACT

An embodiment provides a motor comprising: a shaft; a rotor coupled to the shaft; a stator disposed to correspond to the rotor; and a housing accommodating the stator, the motor comprising a busbar electrically connected to a coil, and a busbar holder for supporting the busbar, wherein the busbar holder includes a first surface disposed toward the housing. The housing includes a second surface facing the first surface, and a cover disposed between the first surface and the second surface.

### TECHNICAL FIELD

The present invention relates to a motor.

### BACKGROUND ART

A motor includes a rotor and a stator. In addition, the rotor rotates due to an electrical interaction between the rotor and the stator. The stator may emit electromagnetic noise. In this case, the emitted electromagnetic noise may affect the operation of the motor or other devices.

### DISCLOSURE

### Technical Problem

Accordingly, the present invention is directed to providing a motor in which electromagnetic noise emitted from a stator is reduced.

### Technical Solution

One aspect of the present invention provides a motor including a shaft, a rotor coupled to the shaft, a stator disposed to correspond to the rotor, a housing which accommodates the stator, a busbar electrically connected to the coil, and a busbar holder which supports the busbar, wherein the busbar holder includes a first surface disposed to face the housing, the housing includes a second surface facing the first surface, and the motor includes a cover disposed between the first surface and the second surface.

The first surface and the second surface may be disposed in an axial direction.

The cover may be coupled to the first surface.

The cover and the first surface may be coupled using an adhesive.

The cover and the busbar holder may be coupled through an insert injection method.

The motor may include a fastening member which fastens the cover and the busbar holder.

The cover may be coupled to the second surface. In this case, the cover and the housing may be coupled through an insert injection method.

In addition, the cover provided as a doughnut-shaped plate may include a plurality of holes in which terminals of the busbar are disposed, and the plurality of holes may include a first hole open inward and a second hole open outward.

A distance from an axial center to a terminal disposed in the first hole in a radial direction may be smaller than a distance from the axial center to a terminal disposed in the second hole in the radial direction.

A shortest distance from the axial center to an inner circumferential surface of the cover in the radial direction may be smaller than a distance from the axial center to an inner circumferential surface of the busbar holder.

Another aspect of the present invention provides a motor including a shaft, a rotor coupled to the shaft, a stator disposed to correspond to the rotor, a housing which accommodates the stator, a busbar electrically connected to the stator, and a busbar holder which supports the busbar, wherein the housing includes a second surface disposed to face the busbar holder and a third surface disposed at an opposite side of the second surface, and a cover is disposed on the third surface.

The second surface and the third surface may be disposed in an axial direction.

The cover and the housing may be coupled through an insert injection method.

The third surface may include a first region and a second region which are disposed to have a predetermined height difference, and the second region may overlap the cover in an axial direction.

The housing may include a stopper formed to protrude from the third surface to prevent separation of the cover.

The cover may include a first cover part which overlaps the second region in the axial direction and a second cover part extending from the first cover part, wherein the second cover part may be disposed outside an outer circumferential surface of the housing.

The busbar holder may include a boss formed to protrude to support the busbar, the housing may include a through hole through which the boss is disposed to pass, and the cover may include a groove portion formed to correspond to the boss.

The motor may further include a cover member disposed to surround an upper portion and a side portion of the stator.

The cover may be formed of any one selected from S45C, stainless steel (SUS), electrogalvanized steel (SECC), or permalloy foil.

### Advantageous Effects

According to an embodiment, electromagnetic noise emitted from a stator can be effectively reduced by improving a cover for blocking an electromagnetic wave and a layout of the cover. Accordingly, the electromagnetic compatibility (EMC) of a motor can be improved.

### DESCRIPTION OF DRAWINGS

FIG. 1 is a cross-sectional view illustrating a motor according to one embodiment of the present invention.

FIG. 2 is a perspective view illustrating a stator, a busbar assembly, and a cover according to one embodiment of the present invention.

FIG. 3 is an exploded perspective view illustrating the stator, the busbar assembly, and the cover according to one embodiment of the present invention.

FIG. 4 is a plan view illustrating the stator, the busbar assembly, and the cover according to one embodiment of the present invention.

FIG. 5 is a cross-sectional view illustrating the stator, the busbar assembly, and the cover according to one embodiment of the present invention.

FIG. 6 is a perspective view illustrating the cover according to one embodiment of the present invention.

FIG. 7 is a cross-sectional view illustrating a motor according to another embodiment of the present invention.

FIG. 8 is an exploded perspective view illustrating a stator, a housing, and a cover according to another embodiment of the present invention.

FIG. 9 is a plan view illustrating the cover disposed on the housing according to another embodiment of the present invention.

FIG. 10 is a plan view illustrating the housing according to another embodiment of the present invention.

FIG. 11 is a perspective view illustrating the cover according to another embodiment of the present invention.

FIG. 12 is a cross-sectional view illustrating a motor according to still another embodiment of the present invention.

### MODES OF THE INVENTION

Hereafter, an exemplary embodiment of the present invention will be described in detail with reference to the accompanying drawings.

A direction parallel to a longitudinal direction (vertical direction) of a shaft is referred to as an axial direction, a direction perpendicular to the axial direction based on the shaft is referred to as a radial direction, and a direction along a circle having a radius in the radial direction based on the shaft is referred to as a circumferential direction.

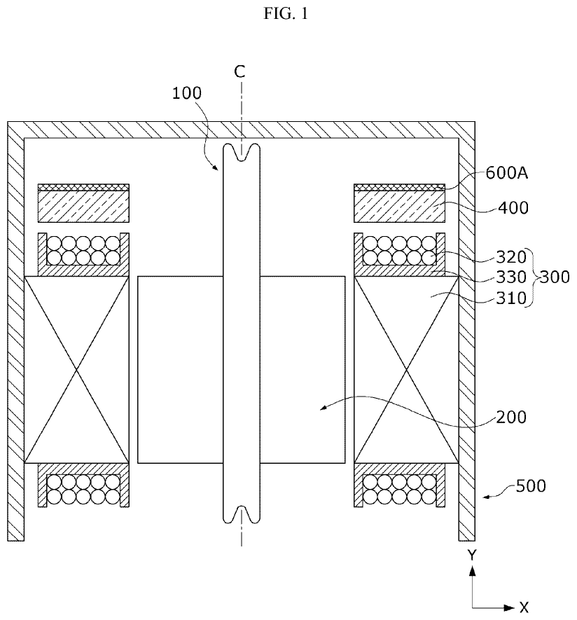

FIG. 1 is a cross-sectional view illustrating a motor according to an embodiment. In FIG. 1, an X direction may be a radial direction, and a Y direction may an axial direction. In addition, a reference symbol “C” illustrated in FIG. 1 may be an axial center of the shaft 100.

Referring to FIG. 1, the motor may include the shaft 100, a rotor 200, a stator 300, a busbar assembly 400, a housing 500 and a cover 600A according to the first embodiment.

Hereafter, the term “inward” is a direction from the housing 500 toward the shaft 100 which is a center C of the motor, and the term “outward” is a direction from the shaft 100 toward the housing 500 which is the direction opposite to “inward”.

The shaft 100 may be coupled to the rotor 200. When a current is supplied, an electromagnetic interaction occurs between the rotor 200 and the stator 300, the rotor 200 rotates, and the shaft 100 rotates in conjunction with the rotor 200. The shaft 100 may be connected to a steering system of a vehicle and transmit power to the steering system.

The rotor 200 rotates due to an electrical interaction between the rotor 200 and the stator 300. The rotor 200 may be disposed inside the stator 300. The rotor 200 may include a rotor core and a rotor magnet disposed on the rotor core.

The stator 300 is disposed outside the rotor 200. The stator 300 may include a stator core 310, a coil 320, and an insulator 330 mounted on the stator core 310. The coil 320 may be wound around the insulator 330. The insulator 330 is disposed between the coil 320 and the stator core 310. The coil induces an electrical interaction with the rotor magnet.

The busbar assembly 400 may be disposed on the stator 300. The busbar assembly 400 may be electrically connected to the stator 300.

The housing 500 may be disposed outside the rotor 200 and the stator 300. The housing 500 may be a cylindrical member having one open side. The shape and a material of the housing 500 may be variously changed. For example, the housing 500 may be formed of a metal material which can withstand high temperatures.

The cover 600A may be disposed on the stator 300 in an axial direction. The cover 600A may block electromagnetic noise emitted from the stator 300.

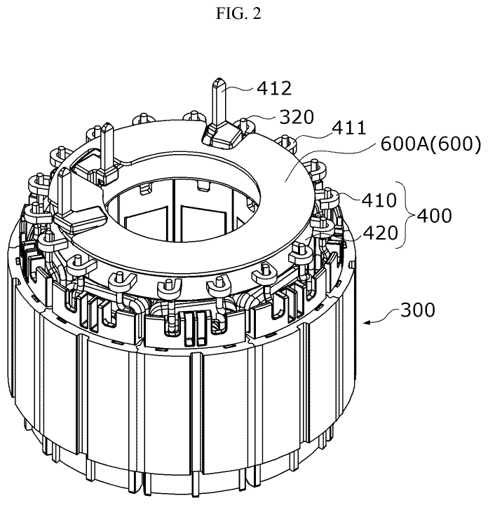

FIG. 2 is a perspective view illustrating the stator, the busbar assembly, and the cover according to one embodiment of the present invention.

Referring to FIG. 2, the cover 600A may be disposed between the busbar assembly 400 and the housing 500. The cover 600A may be coupled to one surface of the busbar assembly 400. In this case, the cover 600A may filter electromagnetic noise directed from the stator 300 toward the busbar assembly 400.

The busbar assembly 400 may be connected to the stator 300 to supply power. The busbar assembly 400 may include a busbar 410 and a busbar holder 420. The busbar 410 may be electrically connected to the coil 320. The busbar 410 may be disposed in the busbar holder 420.

The busbar 410 may include a first terminal 411 and a second terminal 412. The first terminal 411 may be electrically connected to the coil 320. The first terminal 411 may protrude from a side surface of the busbar holder 420. In this case, an end portion of the coil 320 may be fused to the first terminal 411. The second terminal 412 may be connected to the first terminal 411. In addition, the second terminal 412 may be connected to an external power source. The second terminal 412 may be provided as a plurality of second terminals 412. The plurality of second terminals 412 may be connected to a three-phase power source. In this case, the second terminals 412 may protrude from an upper surface of the busbar holder 420. In addition, end portions of the second terminals 412 may be exposed outward from the housing 500.

The busbar holder 420 may support the busbar 410. The busbar holder 420 may include a plurality of grooves. The busbar 410 may be disposed in the grooves. The busbar holder 420 may be formed of an insulating material. The busbar holder 420 and the busbar 410 may be coupled through insert injection.

The busbar holder 420 may have a hollow doughnut shape. The busbar holder 420 may include the upper surface and a lower surface. In this case, the upper surface of the busbar holder 420 is disposed to face the housing 500, and the lower surface of the busbar holder 420 may be disposed to face the stator 300. The upper surface of the busbar holder 420 may be spaced apart from the housing 500. The upper surface of the busbar holder 420 may be referred to as a first surface or a first holder surface. In addition, the lower surface of the busbar holder 420 may be referred to as a second holder surface.

The cover 600A may be disposed on the upper surface of the busbar holder 420. The cover 600A may have a plate shape. For example, the cover 600A may be provided as a doughnut-shaped plate in which a hole is formed in a center thereof. A thickness of the cover 600A in the axial direction may be smaller than a thickness of the busbar holder 420 in the axial direction. The cover 600A may cover the upper surface of the busbar holder 420. In addition, the cover 600A may overlap the coil 320 in the axial direction. Accordingly, the cover 600A may effectively block electromagnetic noise emitted from the stator 300 in the axial direction. In particular, the cover 600A may reduce electromagnetic noise emitted toward an upper surface of the housing 500 and absorb magnetism which may affect magnetism of a magnet (not shown) disposed on an upper end of the shaft 100.

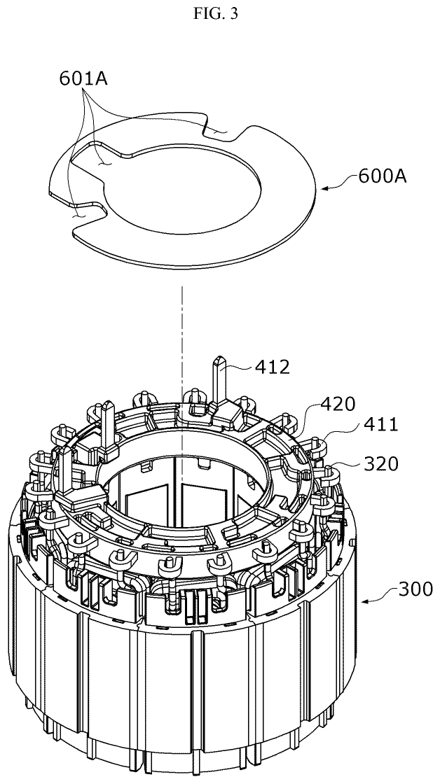

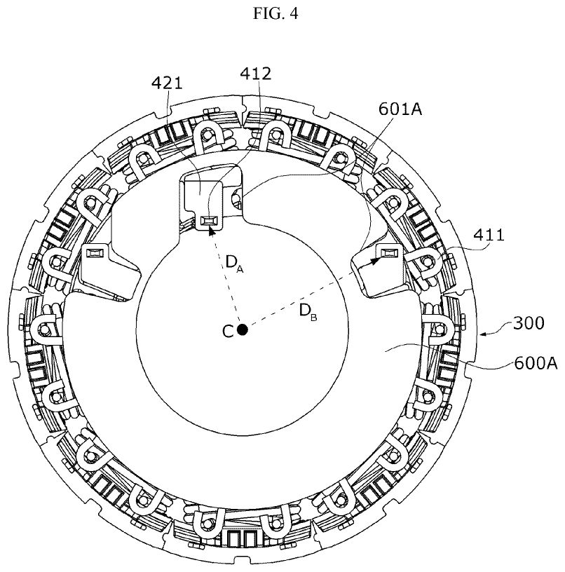

According to the embodiment, the cover 600A may be formed of any one selected from S45C, stainless steel (SUS), electrogalvanized steel (SECC), and permalloy foil. FIG. 3 is an exploded perspective view illustrating the stator, the busbar assembly, and the cover according to one embodiment of the present invention, and FIG. 4 is a plan view illustrating the stator, the busbar assembly, and the cover according to one embodiment of the present invention.

Referring to FIG. 3, the cover 600A may be coupled to the upper surface of the busbar holder 420. The cover 600A may be coupled to the busbar holder 420 through insert injection. For example, an adhesive may be applied between the cover 600A and the upper surface of the busbar holder 420, and the cover 600A may be coupled to the busbar holder 420 by the adhesive.

One region of the busbar holder 420 may overlap the cover 600A in the axial direction. In this case, the busbar holder 420 may include a region which does not overlap the cover 600A in the axial direction. In this case, an area of the cover 600A overlapping the busbar holder 420 may be greater than an area of the cover 600A which does not overlap the busbar holder 420 in the axial direction.

According to the embodiment, a region around the region in which the second terminal 412 of the busbar holder 420 is disposed may be exposed. In this case, the second terminal 412 and an upper end of a first boss 421 may be disposed at levels higher than an upper surface of the cover 600A in the axial direction.

The end portion of the first terminal 411 may not overlap the cover 600A in the axial direction. A distance from an axial center C to the end portion of the first terminal 411 in a radial direction may be greater than a distance from the axial center C to the cover 600A. The end portion of the first terminal 411 may be disposed outside a side surface of the cover 600A in the radial direction.

The busbar holder 420 may include the first boss 421 disposed on the upper surface. The first boss 421 may extend from the upper surface of the busbar holder 420. The second terminal 412 may be disposed on the first boss 421. The first boss 421 may support the second terminal 412.

A plurality of second terminals 412 may pass through the cover 600A. The cover 600A may include a plurality of holes 601A formed to pass through the cover 600A in the axial direction. The plurality of holes 601A may be formed to correspond to positions of the second terminals 412.

The plurality of holes 601A may be spaced apart from each other in a circumferential direction. Any one of the plurality of holes 601A may be open inward of the cover 600A. For example, any one of the plurality of holes 601A may communicate with a hole formed in a center of the cover 600A. Meanwhile, another of the plurality of holes 601A may be open outward of the cover 600A. In this case, among the plurality of holes 601A, the hole open inward may be referred as a first hole, and the hole open outward may be referred to as a second hole. Accordingly, the plurality of holes 601A formed in the cover 600A may include the first hole and the second hole.

The second terminal 412 and the first boss 421 may be disposed in the hole 601A. In this case, the first boss 421 may be referred to as a boss. A length of the second terminal 412 and a length of the first boss 421 in the axial direction may be greater than the thickness of the cover 600A in the axial direction.

The plurality of second terminals 412 may be spaced apart from the axial center C in the radial direction. A distance DA from the axial center C to any one of the plurality of second terminals 412 may be smaller than a distance DB from the axial center C to the other of the plurality of second terminals 412. For example, the second terminal 412 disposed in the first hole may be disposed closer to the axial center C than the second terminal 412 disposed in the second hole. That is, the distance from the axial center C to the second terminal 412 disposed in the first hole in the radial direction may be smaller than the distance from the axial center C to the second terminal 412 disposed in the second hole in the radial direction.

In this case, any one of the plurality of second terminals 412 may be disposed closer to the axial center C than the cover 600A in the radial direction. In addition, the other of the plurality of second terminals 412 may be disposed farther from the axial center C than the cover 600A in the radial direction.

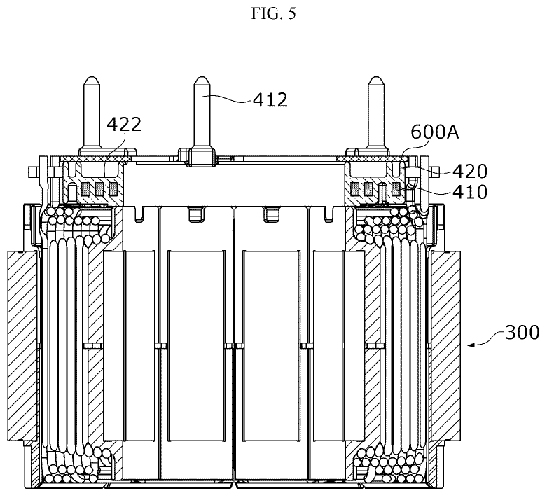

FIG. 5 is a cross-sectional view illustrating the stator, the busbar assembly, and the cover according to one embodiment of the present invention.

Referring to FIG. 5, the busbar holder 420 may be disposed between the stator 300 and the cover 600A in the axial direction. In this case, the busbar 410 may be disposed in the busbar holder 420. In addition, the busbar 410 may be electrically connected to the coil 320 of the stator 300. In addition, the second terminal 412 may be exposed from the busbar holder 420 toward an opposite side of the stator 300. The end portion of the second terminal 412 may be disposed outside the housing 400 (see FIG. 1).

The cover 600A may be disposed at one side of the busbar holder 420. In addition, at least a part of the cover 600A may be in contact with the busbar holder 420. In this case, the cover 600A may be coupled to the busbar holder 420 using an adhesive.

Meanwhile, the cover 600A may be coupled to the busbar holder 420 through insert injection. Alternatively, although not illustrated in the drawing, the motor according to the embodiment may include a fastening part (not shown) disposed between the cover 600A and the busbar holder 420. In addition, the fastening part (not shown) may couple the cover 600A and the busbar holder 420. In this case, the cover 600A and the busbar holder 420 may be coupled through various methods. For example, the cover 600A and the busbar holder 420 may be fastened using a fastening member (not shown) such as a screw.

The busbar holder 420 may include a first portion 422 overlapping the cover 600A in the axial direction. In this case, the first portion 422 may not be in contact with the cover 600A. The first portion 422 may be spaced apart from the cover 600A in the axial direction. In this case, a gap may be formed between the first portion 422 and the cover 600A. As illustrated in FIG. 5, the busbar holder 420 may include a groove concavely formed in the upper surface of the busbar holder 420 in the axial direction. Accordingly, the busbar holder 420 may include the first portion 422 disposed to be spaced from the cover 600A by the groove.

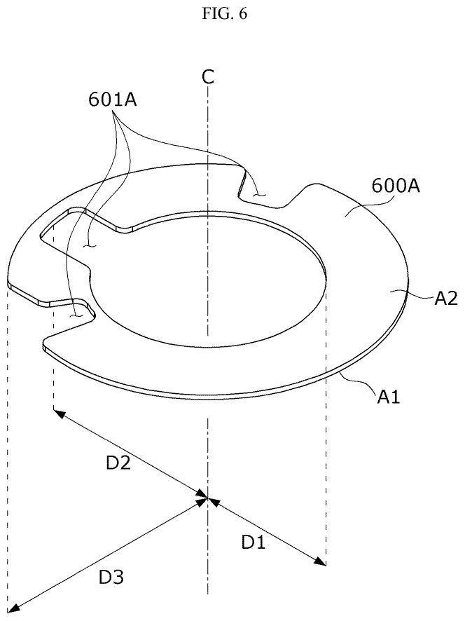

FIG. 6 is a perspective view illustrating the cover according to one embodiment of the present invention.

Referring to FIG. 6, the cover 600A may have a plate disk shape.

The cover 600A may include a first cover surface A1 and a second cover surface A2 disposed in the axial direction. In this case, the first cover surface A1 is disposed to face the stator 300 (see FIG. 1). The first cover surface A1 may be in contact with the upper surface of the busbar holder 420. The second cover surface A2 is disposed to face the housing 500 (see FIG. 1). The second cover surface A2 may be disposed to be spaced apart from the housing 500.

The cover 600A may be spaced apart from the axial center C and may extend in the circumferential direction. For example, the cover 600A may be provided as a doughnut-shaped plate having a hole formed in the center. The cover 600A may have an inner circumferential surface facing the axial center C and an outer circumferential surface facing the outside. The inner circumferential surface of the cover 600A may be spaced from the axial center C in the radial direction. A distance to the inner circumferential surface of the cover 600A from the axial center C may vary according to a position or the cover 600A in the circumferential direction.

A shortest distance D1 from the axial center C to the inner circumferential surface of the cover 600A may be smaller than a distance from the axial center C to an inner circumferential surface of the busbar holder 420. In addition, a longest distance D2 from the axial center C to the inner circumferential surface of the cover 600A may be greater than the distance from the axial center C to the inner circumferential surface of the busbar holder 420. In addition, a distance D3 from the axial center C to the outer circumferential surface of the cover 600A may be greater than a distance from the axial center C to an outer circumferential surface of the busbar holder 420.

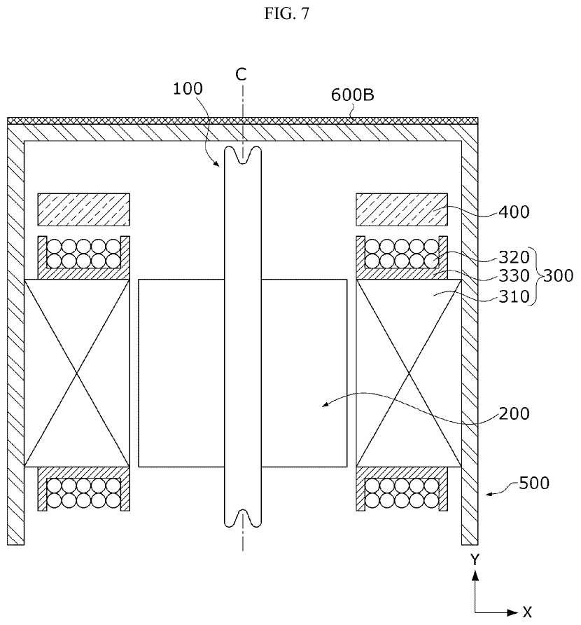

Hereafter, another embodiment of the present invention will be described with reference to FIGS. 7 to 11.

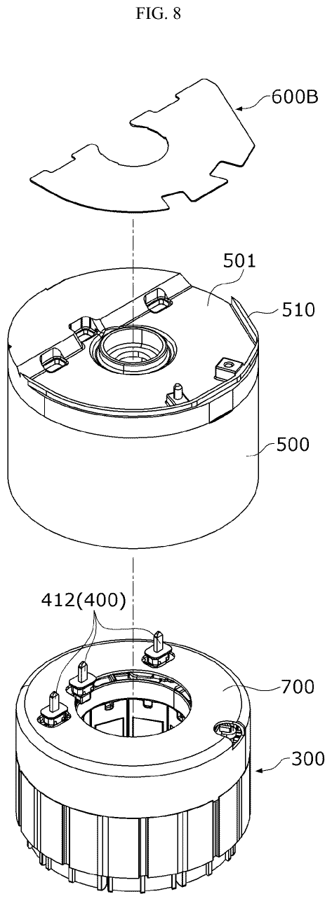

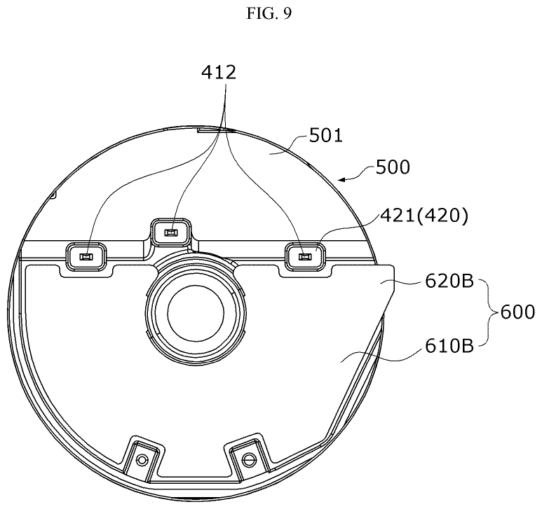

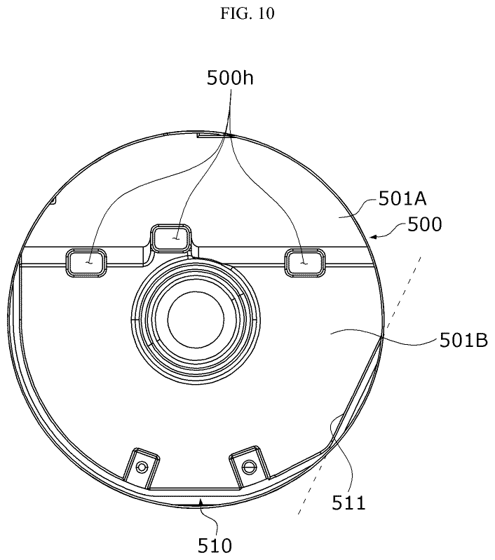

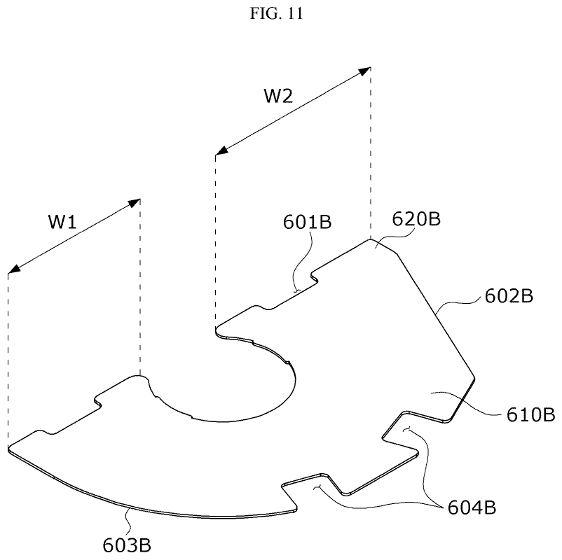

FIG. 7 is a cross-sectional view illustrating a motor according to another embodiment of the present invention, and FIG. 8 is an exploded perspective view illustrating a stator, a housing, and a cover according to another embodiment of the present invention. FIG. 9 is a plan view illustrating the cover disposed on the housing according to another embodiment of the present invention, FIG. 10 is a plan view illustrating the housing according to another embodiment of the present invention, and FIG. 11 is a perspective view illustrating the cover according to another embodiment of the present invention.

The motor of the present embodiment is substantially the same as the motor illustrated in FIG. 1 except for a cover. Accordingly, components which are the same as the components illustrated in FIG. 1 will be assigned with the same reference numerals, and repeating descriptions thereof will be omitted.

Referring to FIGS. 7 to 11, a cover 600B according to a second embodiment may be disposed outside a housing 500.

The cover 600B may be disposed outside the housing 500. The cover 600B may be spaced apart from a stator 300 with the housing 500 interposed therebetween in an axial direction. The cover 600B may be coupled to the housing 500 using an adhesive. Meanwhile, the cover 600B may be coupled to the housing 500 through insert injection.

The motor may include a cover member 700 coupled to the stator 300. In this case, the cover member 700 may have a hollow cylindrical shape having one open side. One surface of the cover member 700 and a busbar assembly 400 may be disposed in the axial direction. In addition, the other surface of the cover member 700 may be disposed outside the busbar assembly 400 in a radial direction. In this case, the cover member 700 may surround an upper portion and a side portion of the busbar assembly 400. In addition, an end portion of the cover member 700 may be fixed to a stator core. According to the embodiment, the cover member 700 may include a protrusion disposed at the end portion. In addition, the protrusion may be coupled to a groove formed in an outer surface of the stator core.

The housing 500 may include a second surface and a third surface 501. The second surface may be disposed to face the stator 300. The second surface may face an upper surface of a busbar holder 420, that is, a first surface. In addition, the third surface 501 may be a surface opposite to the second surface. The third surface 501 may be disposed to face the outside. The cover 600B may be disposed on the third surface 501. In this case, the cover 600B may block electromagnetic noise emitted outward from the housing 500.

The housing 500 may include a first part 510 disposed on the third surface 501. The first part 510 may be disposed outside the cover 600B in the radial direction. In addition, a length of the first part 510 in the axial direction may be greater than a thickness of the cover 600B in the axial direction. That is, an upper end of the first part 510 may be disposed at a level higher than an upper surface of the cover 600B. Accordingly, the first part 510 may prevent the cover 600B from separating in the radial direction. In this case, the first part 510 may be referred to as a stopper or separation prevention barrier.

The housing 500 may include a plurality of through holes 500h disposed in the third surface 501. In addition, second terminals 412 may pass through the through holes 500h and may be exposed from the third surface 501.

The housing 500 may include a coupling part disposed on the third surface 501. The motor according to the embodiment may further include a cover part (not shown) coupled to the housing 500. The housing 500 and cover part (not shown) may constitute an accommodation space. In addition, the motor according to the embodiment may include a printed circuit board (PCB, not shown) disposed in the accommodation space constituted by the housing 500 and the cover part. One surface of the PCB (not shown) may be spaced apart from the third surface 501. In addition, the cover 600B may be disposed between the PCB (not shown) and the third surface 501. Accordingly, the cover 600B may block electromagnetic noise emitted toward the PCB (not shown). For example, since the PCB (not shown) may be disposed on the cover 600B, the electromagnetic noise directed to the PCB (not shown) may be blocked by the cover 600B.

The third surface 501 may include a first region 501A and a second region 501B which are disposed to have a height difference therebetween in the axial direction. In addition, the first region 501A may not overlap the cover 600B in the axial direction. In addition, the cover 600B may be disposed in the second region 501B. The second region 501B and the first region 501A may be disposed in a direction perpendicular to the axial direction. In this case, an area of the second region 501B may be greater than an area of the first region 501A. The cover 600B may be disposed in the second region 501B. The second region 501B may overlap the cover 600B in the axial direction.

The second region 501B may be disposed inside the first part 510. An inner circumferential surface of the first part 510 may be in contact with an edge of the cover 600B disposed in the second region 501B. In this case, a curvature of the inner circumferential surface of the first part 510 may vary according to a position thereof in a circumferential direction. According to the embodiment, the inner circumferential surface of the first part 510 may include a curved surface and a flat surface. The cover 600B may include a region beyond the housing 500.

The cover 600B may be eccentrically disposed in one direction based on an axial center C.

The cover 600B may have a first width W1 and a second width W2 in the radial direction. The second width W2 may be greater than the first width W1.

The cover 600B may include a first portion 610B and a second portion 620B. The first portion 610B may overlap the housing 500 in the axial direction. In this case, the first portion 610B may be disposed in the second region 501B. In addition, the first portion 610B may be disposed inside the first part 510 and may overlap the first part 510 in the radial direction. In this case, the first portion 610B may be referred to as a first cover portion or overlapping portion, and the second portion 620B may be referred to as a second cover portion or non-overlapping portion.

The cover 600B may include a first side surface 602B and a second side surface 603B disposed at the edge of the cover 600B. In addition, a curvature of the first side surface 602B may be different from a curvature of the second side surface 603B. According to the embodiment, the first side surface 602B may be a flat surface. Meanwhile, the second side surface 603B may be a curved surface. In this case, the first side surface 602B and the second side surface 603B may be in contact with an inner surface of the first part 510. The first part 510 may include a first inner surface 511 in contact with the first side surface 602B.

The second portion 620B may extend from an edge of the first portion 610B. An area of the second portion 620B may be smaller than an area of the first portion 610B. The second portion 620B may not overlap the housing 500 in the axial direction. The second portion 620B may be disposed outside an outer circumferential surface of the housing 500 in the radial direction.

The cover 600B may include a first groove portion 601B and a second groove portion 604B. The first groove portion 601B and the second groove portion 604B may be disposed in the edge of the cover 600B. In this case, the first groove portion 601B may be disposed to face a first boss 421 which has passed through a through hole 500h. For example, the first groove portion 601B may be formed to correspond to the first boss 421. In addition, the second groove portion 604B may be disposed to face a protruding portion disposed on the third surface 501.

The cover 600B may be formed of any one selected from S45C, SUS, SECC, and permalloy foil.

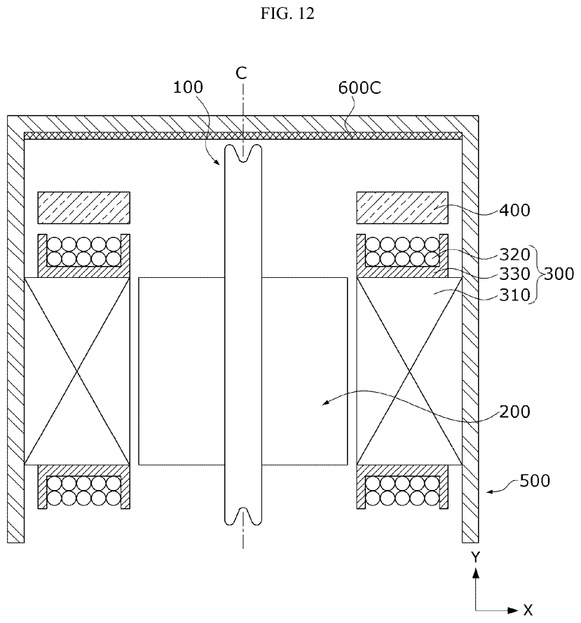

Hereafter, a motor according to still another embodiment of the present invention will be described with reference to FIG. 12.

The motor of the present embodiment is substantially the same as the motor illustrated in FIG. 7 except for a cover. Accordingly, components which are the same as the components illustrated in FIG. 7 will be assigned with the same reference numerals, and repeating descriptions thereof will be omitted.

FIG. 12 is a cross-sectional view illustrating a motor according to still another embodiment of the present invention.

Referring to FIG. 12, a cover 600C according to a third embodiment may be disposed in a housing 500.

The cover 600C may be disposed on an inner surface of the housing 500. The cover 600C may be disposed in an axial direction of a stator 300. The cover 600C may be spaced apart from a busbar assembly 400 in the axial direction.

The cover 600C may have a plate shape. The cover 600C may be coupled to the housing 500 through insert injection. The cover 600C may be formed of any one selected from S45C, SUS, SECC, and permalloy foil. More preferably, the cover may be formed of S45C.

Hereinafter, the present invention will be described in more detail through electromagnetic noise measurement values according to the embodiments. The embodiments are only exemplary in order to describe the present invention in more detail. Accordingly, the present invention is not limited to the embodiments.

Table 1 shows results of detecting electromagnetic noise emitted from motors according to a comparison example and the first to third embodiments.

In this case, the motor according to the first embodiment has the structure illustrated in FIG. 1, the motor according to the second embodiment has the structure illustrated in FIG. 7, and the motor according to the third embodiment has the structure illustrated in FIG. 12. In this case, a phase current of 25 A was applied to each of the motors according to the first to third embodiments, and emitted electromagnetic noise was measured.

TABLE 1

| | | First | | Second |
|---|---|---|---|---|
| | | Measurement | | Measurement |
| | Cover Material | Value | | Value |
| Third | S45C | 13.4 | dB | 13.8 dB |
| Embodiment | | | | |
| Second | SUS430 | 11.4 | dB | 14.1 dB |
| Embodiment | SECC | 13.6 | dB | 13.3 dB |
| | Permalloy Foil | 15.1 | dB | 14.8 dB |
| First | SUS430 | 13 | dB | 11.7 dB |
| Embodiment | SECC | 11.8 | dB | 12.6 dB |

Referring to Table 1, in the motor which has the structure in which the cover is disposed on one surface of the busbar holder as in the first embodiment and in which a material of the cover is SECC, both the first measurement value and the second measurement value were low. It can be seen that an electromagnetic noise reduction effect varies according to the position and material of the cover. Accordingly, since the motor according to the present invention effectively reduces electromagnetic noise emitted from the stator by improving the layout and structure of the cover for blocking electromagnetic wave, the electromagnetic compatibility (EMC) of the motor can be improved.

In the above embodiments, an example of an inner rotor type motor has been described, but the present invention is not limited thereto. The present invention can also be applied to an outer rotor type motor. In addition, the present invention can be used in various devices such as vehicles or home appliances.

### REFERENCE NUMERALS

100: shaft, 200: rotor, 300: stator, 310: stator core, 320: insulator, 330: coil, 400: busbar, 500: housing, 600: cover

1. A motor comprising:
a shaft;
a rotor coupled to the shaft;
a stator disposed to correspond to the rotor;
a housing that accommodates the stator;
a busbar electrically connected to the stator; and
a busbar holder that supports the busbar,
wherein the busbar holder includes a first surface disposed to face the housing,
wherein the housing includes a second surface facing the first surface, and
wherein a cover is disposed between the first surface and the second surface,
wherein the cover includes a plurality of holes, and
some of the plurality of holes are open outward.

2. The motor of claim 1, wherein the first surface and the second surface are disposed in an axial direction.

3. The motor of claim 2, wherein the cover is coupled to the first surface.

4. The motor of claim 3, wherein the cover is coupled to the first surface using an adhesive.

5. The motor of claim 3, wherein the cover is coupled to the busbar holder through insert injection.

6. The motor of claim 3, comprising a fastening member which that fastens the cover and the busbar holder.

7. The motor of claim 2, wherein the cover is coupled to the second surface.

8. The motor of claim 7, wherein the cover is coupled to the housing through insert injection.

9. The motor of claim 3, wherein:
the cover provided as a donut-shaped plate that includes a plurality of holes in which terminals of the busbar are disposed; and
the plurality of holes include a first hole open inward and a second hole open outward.

10. The motor of claim 9, wherein a distance from an axial center to a terminal disposed in the first hole in a radial direction is smaller than a distance from the axial center to a terminal disposed in the second hole in the radial direction.

11. The motor of claim 10, wherein a shortest distance from the axial center to an inner circumferential surface of the cover in the radial direction is smaller than a distance from the axial center to an inner circumferential surface of the busbar holder.

12. A motor comprising:
a shaft;
a rotor coupled to the shaft;
a stator disposed to correspond to the rotor;
a housing that accommodates the stator;
a busbar electrically connected to the stator; and
a busbar holder that supports the busbar,
wherein the housing includes a second surface disposed to face the busbar holder and a third surface disposed at an opposite side of the second surface,
wherein a cover is disposed on the third surface,
wherein the cover includes a plurality of holes, and
some of the plurality of holes are open outward.

13. The motor of claim 12, wherein the second surface and the third surface are disposed in an axial direction.

14. The motor of claim 13, wherein the cover is coupled to the housing through insert injection.

15. The motor of claim 12, wherein:
the third surface includes a first region and a second region that are disposed to have a predetermined height difference; and
the second region overlaps the cover in an axial direction.

16. The motor of claim 15, wherein the housing includes a stopper formed to protrude from the third surface to inhibit separation of the cover.

17. The motor of claim 15, wherein the cover includes:
a first cover part that overlaps the second region in the axial direction; and
a second cover part extending from the first cover part,
wherein the second cover part is disposed outside an outer circumferential surface of the housing.

18. The motor of claim 12, wherein:
the busbar holder includes a boss formed to protrude to support the busbar;
the housing includes a through hole through which the boss is disposed to pass; and
the cover includes a groove portion formed to correspond to the boss.

19. The motor of claim 12, comprising a cover member disposed to surround an upper portion and a side portion of the stator.

20. The motor of claim 1, wherein the cover is formed of any one selected from S45C, stainless steel (SUS), electrogalvanized steel (SECC), and permalloy foil.
